(19) United States
(12) Patent Application Publication
(10) Pub. No.: US 2026/0117897 A1
(43) Pub. Date: Apr. 30, 2026

(54) BALL VALVE-TYPE CORRUGATED PIPE ASSEMBLY

(71) Applicant: TAIZHOU KLOE DAFENG PLUMBING CO., LTD., Taizhou City (CN)

(72) Inventors: Weijie Huang, Taizhou City (CN); Youchun Huang, Taizhou City (CN)

(21) Appl. No.: 19/006,922

(22) Filed: Dec. 31, 2024

(30) Foreign Application Priority Data
Oct. 29, 2024 (CN) 202411520268.8

(51) Int. Cl. F16L 11/118

(52) U.S. Cl. CPC F16L 11/118

(57) ABSTRACT

A ball valve-type corrugated pipe assembly, including: a corrugated pipe, a pipe sleeve assembly, a pipe core assembly, and a sealing gasket. An end of the corrugated pipe is connected to a ball valve, and another end of the corrugated pipe is connected to a threaded connector; the pipe sleeve assembly is connected to an end of the ball valve close to the corrugated pipe and defines a plug-in cavity; the pipe core assembly is arranged on the end of the corrugated pipe close to the ball valve and inserted into the plug-in cavity to engage with the pipe sleeve assembly; the sealing gasket is arranged on an inner wall of the plug-in cavity in an axial direction and configured for a sealed connection between the pipe sleeve assembly and the pipe core assembly.

### CROSS REFERENCE TO RELATED APPLICATIONS

The present application claims the priority of Chinese patent application No. 202411520268.8, filed on Oct. 29, 2024, and the entire contents of which are hereby incorporated by reference in its entirety.

### TECHNICAL FIELD

The present disclosure relates to the technical field of pipe fittings, and specifically to a ball valve-type corrugated pipe assembly.

### BACKGROUND

A corrugated pipe is a tubular elastic sensitive element connected with collapsible wrinkled pieces along a direction of folding and stretching. In order to connect two ends of the corrugated pipe, a connector is provided for each of the two ends. Further, in order to realize adjustable flow rate in the corrugated pipe, the connector at one end is adopted with a ball valve.

Conventionally, the corrugated pipe and the ball valve are usually fixedly connected, which makes the connection prone to leakage caused by deformation at the connection or damage to the rubber gasket due to aging. Because the corrugated pipe and the ball valve are fastened with force, the user cannot repair it, and thus the ball valve-type corrugated pipe assembly is usually directly replaced. However, due to the high cost of the ball valve, the above design tends to lead to high manufacturing costs for the corrugated pipe assembly, resulting in high maintenance and replacement costs.

### SUMMARY OF THE DISCLOSURE

The purpose of the present disclosure is to provide a ball valve-type corrugated pipe assembly that, in response to the above-mentioned technical problems, allows the user to disassemble and assemble the ball valve and corrugated pipe. When a leak occurs at the corrugated pipe or the connection between the corrugated pipe and the ball valve, it is not necessary to replace the entire ball valve-type corrugated pipe assembly, thereby reducing maintenance costs and providing a convenient effect.

In view of this, the present disclosure provides a ball valve-type corrugated pipe assembly, including:
a corrugated pipe; where an end of the corrugated pipe is connected to a ball valve, and another end of the corrugated pipe is connected to a threaded connector;
a pipe sleeve assembly, connected to an end of the ball valve close to the corrugated pipe and defining a plug-in cavity;
a pipe core assembly, arranged on the end of the corrugated pipe close to the ball valve and inserted into the plug-in cavity to engage with the pipe sleeve assembly; and
a sealing gasket, arranged on an inner wall of the plug-in cavity in an axial direction and configured for a sealed connection between the pipe sleeve assembly and the pipe core assembly.

In some embodiments, the pipe core assembly includes:
a cylinder, sleeved on an end of the corrugated pipe and defining an annular chute extending along the axial direction towards the pipe sleeve assembly; where a sliding hole is defined on an inner wall of the annular chute on a side away from an axial center;
a limit block, arranged in the sliding hole; where a convex edge is arranged on an inner wall of the cylinder on an end away from the axial center of the cylinder, for preventing the limit block from slipping out; and
a locking member, sleeved on an inner wall of the annular chute on a side near the axial center and slidably connected to the annular chute in the axial direction, and configured to push the limit block to move radially in the sliding hole;
where an inner wall of the plug-in cavity on a side near the pipe core assembly is bent towards the axial center to form an annular protrusion, and the annular protrusion is configured to abut against the limit block to limit an end of the cylinder to be in the plug-in cavity.

In some embodiments, the locking member includes:
a kit, defining an annular groove configured for the limit block to be returned radially towards the axial center; where an end of the kit is extendable out of the annular chute to abut against the sealing gasket; and
a first spring, arranged axially on a side of the kit away from the sealing gasket, and abutting against the cylinder and the kit at both ends.

In some embodiments, an abutting portion is formed on a side of the kit close to the gasket, and a side of the abutting portion close to the gasket is arranged with a plurality of annular teeth distributed at equal intervals.

In some embodiments, the ball valve-type corrugated pipe assembly further includes:
a snap fastener, arranged on a surface of the pipe core assembly and linked to the kit;
where, in condition of the limit block being engaged with the annular protrusion, an elastic potential energy of the first spring is in an equilibrium state with an elastic potential energy of the sealing gasket; the snap fastener is capable of being disengaged after the equilibrium state is disrupted.

In some embodiments, the snap fastener includes:
a mounting frame, connected to a side of the kit away from the axial center; where a linear chute is defined on the cylinder for the mounting frame to slide axially;
a latch portion, hingedly connected to the mounting frame at one end and bent towards the cylinder at another end to form a latch; and
a lap portion, arranged on a surface of the cylinder away from the axial center and engaged with the latch;
where, after the mounting frame follows an axial movement of the kit, the latch separates from the lap portion.

In some embodiments, an end of the latch is inclined and in point contact with the lap portion.

In some embodiments, the ball valve-type corrugated pipe assembly further includes:
a triggering member, arranged on the kit and configured to push the latch portion to be popped open after the latch is separated from the lap portion.

In some embodiments, the triggering member includes:
a snapping block, arranged on a side of the latch portion close to the cylinder; and
a second spring; where an end of the second spring is arranged on the snapping block, and another end of the second spring abuts against the cylinder.

Further, the present disclosure provides a mounting process for a ball valve-type corrugated pipe assembly, including the following steps.
S1: preparing the ball valve and the corrugated pipe that are matched, and placing the sealing gasket in the plug-in cavity;
S2: flipping the latch portion, and taking the latch portion as a fulcrum to push the mounting bracket and drive the kit to compress the first spring, causing the limit block to match with the annular groove and return radially towards the axial center;
S3: inserting the cylinder into the plug-in cavity; and after the limit block enters, releasing the latch portion;
S4: the elastic potential energy of the first spring is released, which pushes the kit to move, and at the same time pushes the limit block out from the cylinder, such that the abutting portion abuts against the sealing gasket, and causes the limit block to snap into the annular protrusion;
S5: the elastic potential energy of the first spring is in equilibrium with the elastic potential energy of the sealing gasket, flipping the latch portion and compressing the second spring, for causing the latch to latch with the lap portion;
S6: when the elastic potential energy of the sealing gasket decreases due to long-term use, the equilibrium state is broken, and the first spring gradually pushes the kit towards the sealing gasket. After the latch is separated from the lap portion, the elastic potential energy of the second spring is released, and the latch is pushed open;
S7: attempting to flip the latch and cause the latch to latch with the lap portion; when the latch and lap portion are re-latched, returning to S6; when the latch and lap portion cannot be re-latched, entering S8;
S8: flipping the latch portion and taking the latch portion as a fulcrum to push the mounting frame and drive the kit to compress the first spring, for causing the limit block to match with the annular groove and move radially back towards the axial center, and removing the cylinder from the plug-in cavity; and
S9: removing the old sealing gasket and put in a new sealing gasket, then repeating S2-S9.

The beneficial effects of the present disclosure are:
1. A pipe core assembly is arranged at one end of the corrugated pipe, a pipe sleeve assembly that is adapted to be snapped onto the ball valve is arranged on an end of the ball valve, and a plug-in cavity is defined for the pipe core assembly to be inserted for connection, such that the convenience is effectively improved, which facilitates the disassembly and assembly between the ball valve and the corrugated pipe, and reduces the cost of repairing and replacing the corrugated pipe and the sealing gasket.
2. An annular chute is arranged inside the cylinder and the locking member is arranged in the annular chute. Further, the first spring is configured to exert a force to ensure the stability of the engagement between the limit block and the annular protrusion, and the locking member can be always pressed against the sealing gasket, thereby further ensuring the sealing performance and reduce the occurrence of leakage.
3. By providing the snap fastener on a surface of the pipe core assembly and linking it with the kit, when the elastic potential energy of the sealing gasket changes, it will drive the kit and the snap fastener to change. The disconnection of the snap fastener will warn the user, such that he/she can easily observe and determine whether the sealing gasket is required to be replaced.
4. By providing the snap fastener, it is further possible to detect whether it is a false alarm based on whether a re-latching is achieved, and there is no effect on the overall sealing performance. This effectively improves the accurate understanding of the performance of the sealing gasket. In addition, the snap fastener is further taken as a fulcrum for pivoting the locking member, thereby effectively improving the ease of disassembly and assembly of the connection between the ball valve and the corrugated pipe.

### BRIEF DESCRIPTION OF THE DRAWINGS

FIG. 1 is a structural schematic view according to some embodiments of the present disclosure.

FIG. 2 is a cross-sectional schematic view of an internal structure according to some embodiments of the present disclosure.

FIG. 3 is an enlarged view of area A circumscribed in FIG. 2.

FIG. 4 is an enlarged view of area B circumscribed in FIG. 3.

FIG. 5 is an enlarged view of area C circumscribed in FIG. 3.

FIG. 6 is a structural schematic view after a latch and a lap portion are disconnected according to some embodiments of the present disclosure.

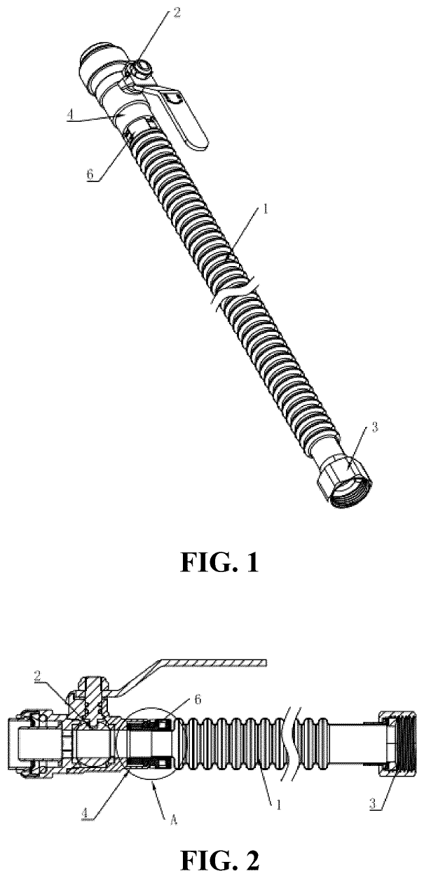

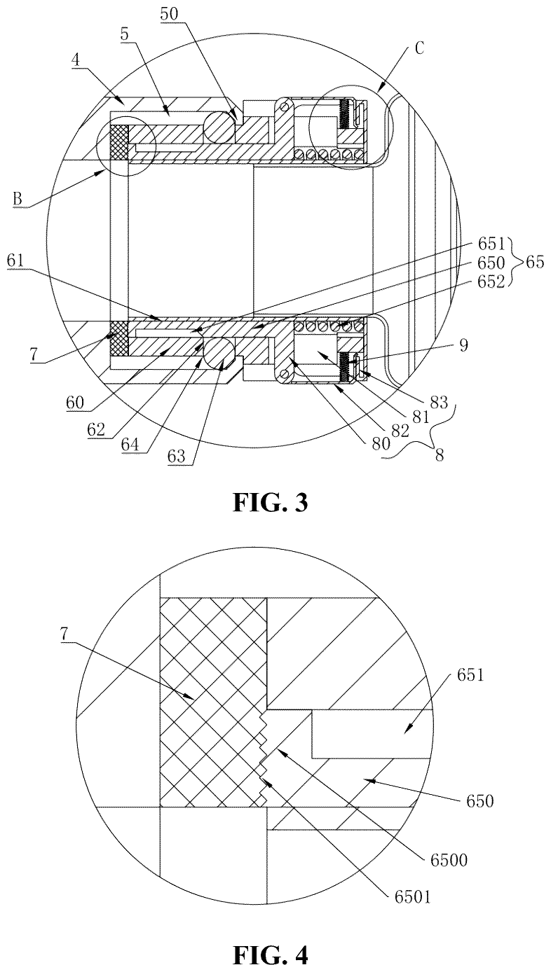

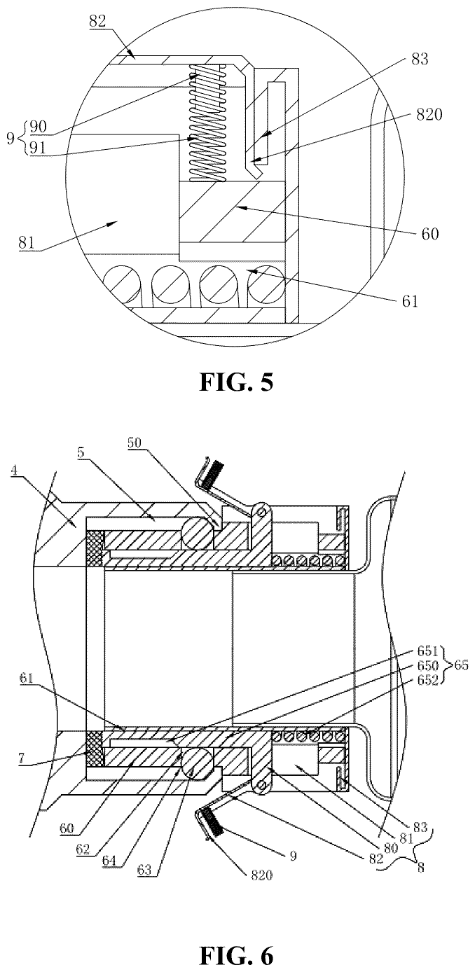

Reference numerals: 1, corrugated pipe; 2, ball valve; 3, threaded connector; 4, pipe sleeve assembly; 5, plug-in cavity; 50, annular protrusion; 6, pipe core assembly; 60, cylinder; 61, annular chute; 62, sliding hole; 63, limit block; 64, convex edge; 65, locking member; 650, kit; 6500, abutting portion; 6501, annular teeth; 651, annular groove; 652, first spring; 7, sealing gasket; 8, snap fastener; 80, mounting frame; 81, linear chute; 82, latch portion; 820, latch; 83, lap portion; 9, triggering member; 90, snapping block; 91, second spring.

### DETAILED DESCRIPTION

The technical solution of the embodiments of the present disclosure will be described in a clear manner below in conjunction with the drawings in the embodiments of the present disclosure. Obviously, the embodiments described are some embodiments but not all of the embodiments of the present disclosure. All other embodiments obtained by those skilled in the art based on the embodiments of the present disclosure fall within the scope of the present disclosure.

### Embodiment 1

The present embodiment provides a ball valve-type corrugated pipe assembly, including:
a corrugated pipe 1; where an end of the corrugated pipe 1 is connected to a ball valve 2, and another end of the corrugated pipe 1 is connected to a threaded connector 3;
a pipe sleeve assembly 4, connected to an end of the ball valve 2 close to the corrugated pipe 1 and defining a plug-in cavity 5;
a pipe core assembly 6, arranged on the end of the corrugated pipe 1 close to the ball valve 2 and inserted into the plug-in cavity 5 to engage with the pipe sleeve assembly 4; and
a sealing gasket 7, arranged on an inner wall of the plug-in cavity 5 in an axial direction and configured for a sealed connection between the pipe sleeve assembly 4 and the pipe core assembly 6;
where the sealing gasket 7 may be made of rubber, and the internal structure of the ball valve 2 is a well-known structure of the prior art, which will not be described in detail herein. The ball valve 2 and the corrugated pipe 1 may both be made of stainless steel.

In the present embodiment, a pipe core assembly 6 is arranged at one end of the corrugated pipe 1, a pipe sleeve assembly 4 that is adapted to be snapped onto the ball valve 2 is arranged on an end of the ball valve 2, and a plug-in cavity 5 is defined for the pipe core assembly 6 to be inserted for connection, such that the convenience is effectively improved, which facilitates the disassembly and assembly between the ball valve 2 and the corrugated pipe 1, and reduces the cost of repairing and replacing the corrugated pipe 1 and the sealing gasket 7.

### Embodiment 2

The present embodiment provides a ball valve-type corrugated pipe assembly, which, in addition to including the technical solution of the above embodiment, further has the following technical features.

The pipe core assembly 6 includes:
a cylinder 60, sleeved on an end of the corrugated pipe 1 and defining an annular chute 61 extending along the axial direction towards the pipe sleeve assembly 4; where a sliding hole 62 is defined on an inner wall of the annular chute 61 on a side away from an axial center;
a limit block 63, arranged in the sliding hole 62; where a convex edge 64 is arranged on an inner wall of the cylinder 60 on an end away from the axial center of the cylinder 60, for preventing the limit block 63 from slipping out; and
a locking member 65, sleeved on an inner wall of the annular chute 61 on a side near the axial center and slidably connected to the annular chute 61 in the axial direction, and configured to push the limit block 63 to move radially in the sliding hole 62;
where an inner wall of the plug-in cavity 5 on a side near the pipe core assembly 6 is bent towards the axial center to form an annular protrusion 50, and the annular protrusion 50 is configured to abut against the limit block 63 to limit an end of the cylinder 60 to be in the plug-in cavity 5;
the limit block 63 is provided in multiple and each may be spherical; the cylinder 60 and the corrugated pipe 1 may be welded, and formed by assembling and welding the inner diameter, outer diameter, and sealing plate.

In the present embodiment, an annular chute 61 is arranged inside the cylinder 60 and the locking member 65 is arranged in the annular chute 61, such that the locking member 65 is protected from the external environment by means of a built-in method, ensuring that the locking member 65 pushes the limit block 63 and the stability of the engagement between the limit block 63 and the annular protrusion 50.

The convex edge 64 can prevent the limit block 63 from slipping out of the sliding hole 62. That is, during installation, the limit block 63 may be prevented from slipping out of the sliding hole 62, thereby improving the installation stability of the limit block 63.

### Embodiment 3

The present embodiment provides a ball valve-type corrugated pipe assembly, which, in addition to including the technical solutions of the above embodiments, further has the following technical features.

The locking member 65 includes:
a kit 650, defining an annular groove 651 configured for the limit block 63 to be returned radially towards the axial center; where an end of the kit 650 is extendable out of the annular chute 61 to abut against the sealing gasket 7; and
a first spring 652, arranged axially on a side of the kit 650 away from the sealing gasket 7, and abutting against the cylinder 60 and the kit 650 at both ends.

In the present embodiment, by providing the locking member 65 to the kit 650 and placing it in the annular chute 61, the stability of the movement of the kit 650 may be improved. Further, the annular groove 651 is provided to facilitate the return of the limit block 63 along the radial direction to the axial center, thereby releasing the engagement between the limit block 63 and the annular protrusion 50, which facilitates disassembly and assembly;

In addition, the first spring 652 is configured to exert a force to ensure the stability of the engagement between the limit block 63 and the annular protrusion 50, and the locking member 65 can be always pressed against the sealing gasket 7, thereby further ensuring the sealing performance and reduce the occurrence of leakage.

### Embodiment 4

The present embodiment provides a ball valve-type corrugated pipe assembly, which, in addition to including the technical solutions of the above embodiments, further has the following technical features.

An abutting portion 6500 is formed on a side of the kit 650 close to the gasket 7, and a side of the abutting portion 6500 close to the gasket 7 is arranged with multiple annular teeth 6501 distributed at equal intervals.

In the present embodiment, by forming an abutting portion 6500 on the side of the kit 650 close to the sealing gasket 7, the contact area between the kit 650 and the sealing gasket 7 may be increased, thereby increasing the sealing area and ensuring the sealing performance. The annular teeth 6501 can facilitate the formation of a corrugated surface between the abutting portion 6500 and the sealing gasket 7, thereby further increasing the effective sealing area and improving the sealing performance.

### Embodiment 5

The present embodiment provides a ball valve-type corrugated pipe assembly, which, in addition to including the technical solutions of the above embodiments, further has the following technical features.

The ball valve-type corrugated pipe assembly further includes:
a snap fastener 8, arranged on a surface of the pipe core assembly 6 and linked to the kit 650;
where, when the limit block 63 is engaged with the annular protrusion 50, the elastic potential energy of the first spring 652 is in equilibrium with the elastic potential energy of the sealing gasket 7, and the snap fastener 8 can be disengaged after the equilibrium state is disrupted.

The snap fastener 8 is provided in at least two.

In the present embodiment, by providing the snap fastener 8 and linking it with the kit 650, when the elastic potential energy of the first spring 652 is in equilibrium with the elastic potential energy of the sealing gasket, the snap fastener 8 is in a connected state. When the elastic potential energy of the sealing gasket 7 is reduced due to aging or other reasons, the equilibrium state will be disrupted, and the first spring 652 will push the kit 650 to move, and the connection of the snap fastener 8 will be released. The state of the sealing gasket 7 can be understood by observing the snap fastener 8, which facilitates the timely replacement of the sealing gasket 7 to ensure sealing performance.

Further, when the equilibrium state is disrupted, the kit 650 moves under the action of the first spring 652 and always abuts against the sealing gasket 7, thereby effectively ensuring the sealing performance. When the kit 650 always abuts against the sealing gasket 7, the limit block 63 is caused to always abut against the annular protrusion 50, thereby effectively ensuring the stability of the snap fit between the two.

### Embodiment 6

The present embodiment provides a ball valve-type corrugated pipe assembly, which, in addition to including the technical solutions of the above embodiments, further has the following technical features.

The snap fastener 8 includes:
a mounting frame 80, connected to a side of the kit 650 away from the axial center; where a linear chute 81 is defined on the cylinder 60 for the mounting frame 80 to slide axially;
a latch portion 82, hingedly connected to the mounting frame 80 at one end and bent towards the cylinder 60 at another end to form a latch 820; and
a lap portion 83, arranged on a surface of the cylinder 60 away from the axial center and engaged with the latch 820;
where, after the mounting frame 80 follows an axial movement of the kit 650, the latch 820 separates from the lap portion 83.

The mounting frame 80 and the kit 650 may be in an integral structure, and the lap portion 83 is formed after a sealing plate portion that constitutes the cylinder 60 is bent by extension. The linear chute 81 satisfies that, after the equilibrium state is destroyed, the mounting frame 80 continues to move with the kit 650, and the distance dimension is slightly greater than the length dimension of a latched portion when the latch portion 820 and the lap portion 83 are in a latched state, thereby ensuring that the latch portion 820 can be unlatched from the lap portion 83.

In the present embodiment, the latch portion 82 is hingedly connected to the mounting frame 80 at one end, and the other end of the latch portion 82 forms a latch 820 that engages with the lap portion 83. When the mounting frame 80 moves with the kit 650, the latch 820 is unlatched from the lap portion 83, such that the latch portion 82 can be tilted along its hinge with the mounting frame 80, which is easy for the user to observe, and then understand that the elastic potential energy of the sealing gasket 7 has decreased and a replacement is required.

Furthermore, the connection and disconnection of the snap fastener 8 is the latching and unlatching of the latch 820 and the lap portion 83, which will not affect the sealing performance and the stability of the connection. It can prevent the sealing performance and the stability of the connection from being affected when it has a warning effect.

In addition, after the latch portion 82 is flipped, force can be applied to the latch 820 to push the kit 650 to compress the first spring 652, thereby improving the convenience of adjusting the kit 650 and facilitating the disassembly and assembly of the connection between the ball valve 2 and the corrugated pipe 1 without the need for tools.

Moreover, the latch 820 is latched with the lap portion 83, and the latch portion 82 is hingedly connected to the mounting bracket 80, such that when the latch 820 and lap portion 83 are accidentally (e.g., due to vibration) disengaged, it is possible to manually turn the latch portion 82, such that the latch 820 and the lap portion 83 can be re-latched. Whether or not the latch 820 and the lap portion 83 can be re-latched is observed to determine whether the sealing gasket 7 is required to be replaced, which provides a convenient and effective means of detecting accidental disengagement.

### Embodiment 7

The present embodiment provides a ball valve-type corrugated pipe assembly, which, in addition to including the technical solutions of the above embodiments, further has the following technical features.

An end of the latch 820 is inclined and in point contact with the lap portion 83.

In the present embodiment, by setting an end of the latch 820 at an angle, the latch 820 is in point contact with the lap portion 83, thereby effectively reducing the frictional resistance between the two, preventing excessive friction between the two from affecting the movement of the kit 650, and thus ensuring that the latch 820 is disconnected from the lap portion 83.

Furthermore, by adjusting the inclined angle, a trigger distance for engaging the latch 820 with the lap portion 83 can be controlled, thereby ensuring the feasibility of the feedback for detecting the aging of the gasket 7 and the adjustment effect.

### Embodiment 8

The present embodiment provides a ball valve-type corrugated pipe assembly, which, in addition to including the technical solutions of the above embodiments, further has the following technical features.

The ball valve-type corrugated pipe assembly further includes:
a triggering member 9, arranged on the kit 650 and configured to push the latch portion 82 to be popped open after the latch 820 is separated from the lap portion 83.

In the present embodiment, by providing the triggering member 9, the degree to which the latch 82 opens after the latch 820 is unlatched from the lap portion 83 can be amplified, thereby improving the warning effect.

### Embodiment 9

The present embodiment provides a ball valve-type corrugated pipe assembly, which, in addition to including the technical solutions of the above embodiments, further has the following technical features.

The triggering member 9 includes:
a snapping block 90, arranged on a side of the latch portion 82 close to the cylinder 60; and
a second spring 91; where an end of the second spring 91 is arranged on the snapping block 90, and another end of the second spring 91 abuts against the cylinder 60;
where the snapping block 90 and the latch portion 82 are integrally formed.

In the present embodiment, the snapping block 90 facilitates the installation of the second spring 91, preventing the second spring 91 from falling off when the latch portion 82 is popped open after the latch 820 and the lap portion 83 are unlatched, thereby providing stability for the installation of the second spring 91. In addition, it is further convenient for the second spring 91 to be compressed again by the latch portion 82 after a false alarm, and to facilitate the latch 820 to latch with the lap portion 83.

### Embodiment 10

The present embodiment provides a mounting process for a ball valve-type corrugated pipe assembly, including the following steps.
S1: preparing the ball valve 2 and the corrugated pipe 1 that are matched, and placing the sealing gasket 7 in the plug-in cavity 5;
S2: flipping the latch portion 82, and taking the latch portion 82 as a fulcrum to push the mounting bracket 80 and drive the kit 650 to compress the first spring 652, causing the limit block 63 to match with the annular groove 651 and return radially towards the axial center;
S3: inserting the cylinder 60 into the plug-in cavity 5; and after the limit block 63 enters, releasing the latch portion 82;
S4: the elastic potential energy of the first spring 652 is released, which pushes the kit 650 to move, and at the same time pushes the limit block 63 out from the cylinder 60, such that the abutting portion 6500 abuts against the sealing gasket 7, and causes the limit block 63 to snap into the annular protrusion 50;
S5: the elastic potential energy of the first spring 652 is in equilibrium with the elastic potential energy of the sealing gasket 7, flipping the latch portion 82 and compressing the second spring 91, for causing the latch 820 to latch with the lap portion 83;
S6: when the elastic potential energy of the sealing gasket 7 decreases due to long-term use, the equilibrium state is broken, and the first spring 652 gradually pushes the kit 650 towards the sealing gasket 7. After the latch 820 is separated from the lap portion 83, the elastic potential energy of the second spring 91 is released, and the latch 82 is pushed open;
S7: attempting to flip the latch 82 and cause the latch 820 to latch with the lap portion 83; when the latch 820 and lap portion 83 are re-latched, returning to S6; when the latch 820 and lap portion 83 cannot be re-latched, entering S8;
S8: flipping the latch portion 82 and taking the latch portion 82 as a fulcrum to push the mounting frame 80 and drive the kit 650 to compress the first spring 652, for causing the limit block 63 to match with the annular groove 651 and move radially back towards the axial center, and removing the cylinder 60 from the plug-in cavity 5; and
S9: removing the old sealing gasket 7 and put in a new sealing gasket 7, then repeating S2-S9.

As can be seen in this embodiment, by connecting the ball valve 2 to the corrugated pipe 1 in a way that facilitates disassembly and assembly by means of a snap fit, when damage occurs at the corrugated pipe 1 or the connection between the corrugated pipe 1 and the ball valve 2 and replacement is required, the ball valve 2 is not required to be replaced, thereby effectively reducing maintenance costs. In addition, the user can operate easily, improving usage convenience.

Meanwhile, after the ball valve 2 is connected to the corrugated pipe 1, the first spring 652 and the sealing gasket 7 exert a force on the kit 650 at the same time and are in an equilibrium state. When the elastic potential energy decreases due to aging of the sealing gasket 7, etc., which in turn disrupts the equilibrium state, the first spring 652 will drive the kit 650, mounting frame 80, and latch portion 82 to move, causing the latch 820 to disengage from the lap portion 83, thereby serving as a warning that the gasket 7 is required to be replaced and allowing the user for an easy observation.

Furthermore, the hinged connection between the latch portion 82 and the mounting frame 80 can, after the latch 820 is unlatched from the lap portion 83, cause the latch 820 to latch again with the lap portion 83 by pivoting the latch portion 82. The accuracy of the warning and the timeliness of the need to replace the sealing gasket 7 are ensured by determining whether it is a false alarm based on a determination whether the latch 820 and lap portion 83 can be re-latched.

The latch portion 82, which has been flipped, can be taken as a fulcrum, making it easy for the user to exert force on it, which in turn causes the kit 650 to move, causing the limit block 63 to match with the annular groove 651, thereby releasing the latching between the ball valve 2 and the corrugated pipe 1. In this way, no additional tools are required, which effectively improves the ease of disassembly and assembly between the two.

Moreover, the latching and unlatching of the latch 820 and the lap portion 83 will not affect the sealing performance of the sealing gasket 7 or the engagement between the limit block 63 and the annular protrusion 50. When a warning is issued, the sealing performance and the stability of the engagement can be maintained. In addition, the elastic potential energy of the first spring 652 can always push the kit 650 against the sealing gasket 7, thereby keeping the limit block 63 latched with the annular protrusion 50, which can effectively ensure the sealing performance and the stability of the engagement between the ball valve 2 and the corrugated pipe 1.

The above is description of the embodiments of the present disclosure in combination with the accompanying drawings, and the embodiments and features thereof may be combined with each other to the extent that they do not conflict. The present disclosure is not limited to the above specific embodiments, which are merely illustrative and not restrictive. Those skilled in the art, under the inspiration of the present disclosure and without departing from the purpose of the present disclosure and the scope protected by the claims, can make many forms, all of which fall within the scope of the present disclosure.

What is claimed is:

1. A ball valve-type corrugated pipe assembly, comprising:
a corrugated pipe (1); where an end of the corrugated pipe (1) is connected to a ball valve (2), and another end of the corrugated pipe (1) is connected to a threaded connector (3);
a pipe sleeve assembly (4), connected to an end of the ball valve (2) close to the corrugated pipe (1) and defining a plug-in cavity (5);
a pipe core assembly (6), arranged on the end of the corrugated pipe (1) close to the ball valve (2) and inserted into the plug-in cavity (5) to engage with the pipe sleeve assembly (4); and
a sealing gasket (7), arranged on an inner wall of the plug-in cavity (5) in an axial direction and configured for a sealed connection between the pipe sleeve assembly (4) and the pipe core assembly (6).

2. The ball valve-type corrugated pipe assembly according to claim 1, wherein the pipe core assembly (6) comprises:
a cylinder (60), sleeved on an end of the corrugated pipe (1) and defining an annular chute (61) extending along the axial direction towards the pipe sleeve assembly (4); wherein a sliding hole (62) is defined on an inner wall of the annular chute (61) on a side away from an axial center;
a limit block (63), arranged in the sliding hole (62); wherein a convex edge (64) is arranged on an inner wall of the cylinder (60) on an end away from the axial center of the cylinder (60), for preventing the limit block (63) from slipping out; and
a locking member (65), sleeved on an inner wall of the annular chute (61) on a side near the axial center and slidably connected to the annular chute (61) in the axial direction, and configured to push the limit block (63) to move radially in the sliding hole (62);
wherein an inner wall of the plug-in cavity (5) on a side near the pipe core assembly (6) is bent towards the axial center to form an annular protrusion (50), and the annular protrusion (50) is configured to abut against the limit block (63) to limit an end of the cylinder (60) to be in the plug-in cavity (5).

3. The ball valve-type corrugated pipe assembly according to claim 2, wherein the locking member (65) comprises:
a kit (650), defining an annular groove (651) configured for the limit block (63) to be returned radially towards the axial center; wherein an end of the kit (650) is extendable out of the annular chute (61) to abut against the sealing gasket (7); and
a first spring (652), arranged axially on a side of the kit (650) away from the sealing gasket (7), and abutting against the cylinder (60) and the kit (650) at both ends.

4. The ball valve-type corrugated pipe assembly according to claim 3, wherein an abutting portion (6500) is formed on a side of the kit (650) close to the gasket (7), and a side of the abutting portion (6500) close to the gasket (7) is arranged with a plurality of annular teeth (6501) distributed at equal intervals.

5. The ball valve-type corrugated pipe assembly according to claim 3, wherein the ball valve-type corrugated pipe assembly further comprises:
a snap fastener (8), arranged on a surface of the pipe core assembly (6) and linked to the kit (650);
wherein, in condition of the limit block (63) being engaged with the annular protrusion (50), an elastic potential energy of the first spring (652) is in an equilibrium state with an elastic potential energy of the sealing gasket (7); the snap fastener (8) is capable of being disengaged after the equilibrium state is disrupted.

6. The ball valve-type corrugated pipe assembly according to claim 5, wherein the snap fastener (8) comprises:
a mounting frame (80), connected to a side of the kit (650) away from the axial center; wherein a linear chute (81) is defined on the cylinder (60) for the mounting frame (80) to slide axially;
a latch portion (82), hingedly connected to the mounting frame (80) at one end and bent towards the cylinder (60) at another end to form a latch (820); and
a lap portion (83), arranged on a surface of the cylinder (60) away from the axial center and engaged with the latch (820);
wherein, after the mounting frame (80) follows an axial movement of the kit (650), the latch (820) separates from the lap portion (83).

7. The ball valve-type corrugated pipe assembly according to claim 6, wherein an end of the latch (820) is inclined and in point contact with the lap portion (83).

8. The ball valve-type corrugated pipe assembly according to claim 6, wherein the ball valve-type corrugated pipe assembly further comprises:
a triggering member (9), arranged on the kit (650) and configured to push the latch portion (82) to be popped open after the latch (820) is separated from the lap portion (83).

9. The ball valve-type corrugated pipe assembly according to claim 8, wherein the triggering member (9) comprises:
a snapping block (90), arranged on a side of the latch portion (82) close to the cylinder (60); and
a second spring (91); wherein an end of the second spring (91) is arranged on the snapping block (90), and another end of the second spring (91) abuts against the cylinder (60).
